(19) United States
(12) Patent Application Publication
(10) Pub. No.: US 2020/0174860 A1
(43) Pub. Date: Jun. 4, 2020

(54) METHOD FOR DISPLAYING MESSAGES OF A COMMUNICATION SYSTEM

(71) Applicant: dSPACE digital signal processing and control engineering GmbH, Paderborn (DE)

(72) Inventor: Bjoern Mueller, Paderborn (DE)

(21) Appl. No.: 16/697,214

(22) Filed: Nov. 27, 2019

(30) Foreign Application Priority Data
Nov. 29, 2018 (DE) 102018130289.4

(51) Int. Cl. G06F 9/54; G06F 11/34

(52) U.S. Cl. CPC G06F 9/546; G06F 11/3476; G06F 11/3457

(57) ABSTRACT

A method for displaying messages of a communication system includes: exchanging, via the communication system, messages between a control unit to be tested and a test environment; creating, receiving and processing, by at least one processing unit of the test environment, messages for the message exchange with the control unit to be tested as well as for command processing by a viewer of the at least one processing unit; displaying, by a display device of the test environment, all received messages in a first display element in a first view; checking, by the viewer, each received message in accordance with a filter instruction; and in response to the check being positive for a respective message, additionally displaying, in a second display element in a second view, the respective message.

### CROSS-REFERENCE TO RELATED APPLICATIONS

Priority is claimed to German Patent Application No. DE 102018130289.4, filed on Nov. 29, 2018, the entire disclosure of which is hereby incorporated by reference herein.

### FIELD

The present invention relates to a method for displaying messages of a communication system, a control unit to be tested being connected via the communication system to a test environment, the test environment and the control unit to be tested exchanging messages via the communication system, and the test environment having at least one processing unit for creating, receiving and processing messages for the message exchange with the control unit to be tested as well as for command processing, in particular command processing by a viewer, and further having an input device for user command input and a display device, the display device displaying all received messages in a first display element in a first view, the viewer stored in the processing unit checking each received message in accordance with a filter instruction and, if the check is positive, the respective message being additionally displayed in a second display element in a second view.

The present invention also relates to a test environment for carrying out the method according to the present invention.

### BACKGROUND

When developing control devices, for example for the automotive industry, it is common to analyze, or display for analysis, the message traffic exchanged by the control unit with its environment via a communication system. This may be done, for example, in a hardware-in-the-loop (HIL) simulation, in which the control unit to be developed, i.e., to be tested, communicates via a communication system with a real-time computer, the real-time computer sending the data expected from the control unit to be tested (or also manipulated data; i.e., data deliberately provided with errors) to the control unit and also receiving messages from the control unit to be tested, which may then be analyzed to check the proper functioning of the control unit.

For purposes of analysis, the exchanged messages may, on the one hand, be recorded and analyzed afterwards. However, it is often desired to monitor the messages during the test, e.g., to detect abnormalities already during simulation and, in certain situations, to intervene directly in the simulation.

Examples of tools that enable the display of messages in such test environments include the BusNavigator from dSPACE GmbH or the CANalyzer from Vector Informatik GmbH.

A problem with the display of messages during operation (online) is that a large number of messages are displayed during a short period of time, which makes it difficult for the user to identify individual messages based on specific properties and to focus thereon. The use of filters or further display elements may be helpful for this purpose, but the context in which a specific message was sent (e.g., the messages before or after the message under consideration) is thereby often lost.

### SUMMARY

In an exemplary embodiment, the present invention provides a method for displaying messages of a communication system. The method includes: exchanging, via the communication system, messages between a control unit to be tested and a test environment; creating, receiving and processing, by at least one processing unit of the test environment, messages for the message exchange with the control unit to be tested as well as for command processing by a viewer of the at least one processing unit; displaying, by a display device of the test environment, all received messages in a first display element in a first view; checking, by the viewer, each received message in accordance with a filter instruction; and in response to the check being positive for a respective message, additionally displaying, in a second display element in a second view, the respective message. The first display element and the second display element are interconnected by a common interface. An input command that acts on the first display element will also act equally on the second display element and/or an input command that acts on the second display element will also act equally on the first display element.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 shows an example of a test environment for an HIL test;

FIG. 2 shows an example of a test environment for virtual validation of a control unit;

FIG. 3 illustrates control of display elements in accordance with an exemplary embodiment of the present invention;

FIG. 4 shows a display of filtered messages in accordance with an exemplary embodiment of the present invention; and

FIG. 5 shows an input interface for a filter according to an exemplary embodiment of the present invention.

### DETAILED DESCRIPTION

Exemplary embodiments of the present invention provide a method and a test environment.

In an exemplary embodiment, the first display element and the second display element are interconnected by a common interface so that an input command that acts on the first display element will also act equally on the second display element and/or an input command that acts on the second display element will also act equally on the first display element.

An advantage of this exemplary embodiment is that it eliminates the need for the user to input commands related, for example, to the representation of a specific message separately for the two display elements. This saves the user from having to activate both display elements or change an activation with a mouse click or a key combination. Such an activation process requires time and attention that the user is now able to devote to the monitoring of the message traffic with the aid of the present invention.

In a further embodiment of the present invention, the first display element is provided by a first display window, and the second display element is provided by a second display window or a separate display region in the first display element.

While spatial separation of the display elements via a second display window may lead to a better overview, the display in a separate display region in the first display element makes it possible to better grasp the context in which the respective message was sent.

According to a further embodiment of the present invention, the communication system is provided by a bus system (for example, a Controller Area Network (CAN), Local Interconnect Network (LIN), or FlexRay) or by a communication network (for example, an automotive Ethernet network).

In a further embodiment, the first and second views are each provided respectively by a continuous, static or hierarchical display mode of the messages displayed, a message being displayable in different display modes in the first view and in the second view.

A “continuous display mode” is understood herein to mean a continuous chronological listing of all messages. This may include each message being specified, inter alia, with identity (ID), time stamp, message content in a respective line in the list.

A “static display mode” is understood to mean a display mode in which, for each message, only one line is listed. The time stamp and the message content may be updated each time the message frame is received anew.

A “hierarchical display mode” is understood herein to mean that the messages are displayed in a hierarchical tree structure. This may include the messages being sorted by their ID under which each newly arriving message is displayed in a new line.

Messages of interest may be displayed in different display modes in the different display elements, each display mode having its advantages, and yet commands can act simultaneously on both display modes of the different display elements.

In a further embodiment of the present invention, an input command is provided by a search command, a freeze command or a selection command (e.g., a selection to highlight).

The search command allows searching for specific messages, contents or information related to messages in a view. The freeze command makes it possible to stop the display from being refreshed or updated, so that the display in the display element remains unchanged until the freeze command is cleared. After the freeze command is cleared, generally, current data are displayed again; i.e., all intermediate data are discarded.

In a further embodiment, it is possible to select for a command, on the first display element, if the command, when input by the user, will also act equally on the second display element and/or to select, on the second display element, if the command, when input by the user, will also act equally on the first display element.

Thus, the present invention makes it possible to change settings optionally and selectively for each command. This is advantageous when the user does not want to apply each command equally to both display elements.

In a further embodiment of the present invention, it is possible to select, via the test environment, for a first filter instruction that, depending on the event of a hit for the first filter instruction, a second conditional filter instruction will activate.

For example, the user of the present invention may desire that a second filter be activated if the filter result for a specific message content of a first message is positive, so that a second message received immediately before and/or immediately after the filtered first message will also be filtered and displayed in the second display element. Another example would be that a first filter for a sleep command in the content of a first message will apply a filter to all messages sent by the control unit that has received the sleep command if the filter result is positive, so that a violation of the sleep command will easily be detected.

In another embodiment of the present invention, a setting according to which a filter instruction will be active only for a limited period of time can be made on the test environment, for example, via the viewer and based on a command input from the user.

In accordance with an exemplary embodiment, the second display element advantageously provides a better overview and will not be permanently overloaded with filtered messages. Some information items are needed only for a limited period of time. This embodiment allows the display duration to be preset or limited.

In a further embodiment, the communication system is composed of a plurality of technically different communication systems, and the messages from the different communication systems are jointly displayed in the first and/or second display element(s).

Parallel display of messages from different communication systems in a single display element allows, for example, for improved tracking of messages that are sent from one communication system to another through a gateway.

In another embodiment of the present invention, the control unit to be tested is provided by a virtual control unit, and the communication system is provided by a simulated communication system.

In accordance with an exemplary embodiment of the present invention, the control unit to be tested is connected to the real-time computer of an HIL system and tested as a real control unit, or the control unit to be tested is simulated and tested as a virtual control unit on a personal computer (PC).

Control units are tested at different stages during development. In early development phases, the control unit functionality may exist in a software implementation and is tested, for example, in the form of virtual control units, on simulation platforms that simulate the entire environment of the (virtual) control unit. Such tests are not yet performed under real-time conditions. This corresponds to offline simulation. In such simulation environments, it is also possible to simulate bus systems and test the message traffic between virtual control units.

In a later development phase, the control unit may be implemented in hardware and software and is tested in an HIL test.

Advantageously, exemplary embodiments of the present invention can be used both for the HIL test and for the virtual test.

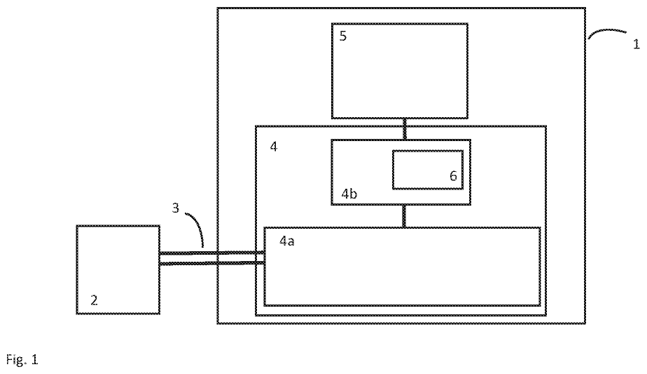

FIG. 1 shows a test environment 1 for an HIL test of a control unit 2. The control unit 2 to be tested is connected via a communication system 3 to a simulator 4a, which is here provided by a real-time simulator. The real-time simulator computes the messages expected by the control unit 2 to be tested and makes them available to control unit 2 in accordance with the prevailing real-time conditions. Typically, the real-time simulator is connected to a conventional PC 4b that has stored thereon, inter alia, a viewer 6 as a monitoring program, which serves to display to the user selected messages and data on a display screen connected to, or forming part of, PC 4b, namely the display device 5. Test environment 1 further includes an input device for user command input, typically in the form of a mouse and a keyboard at PC 4b. The combination of real-time simulator and PC 4b is referred to herein as processing unit 4.

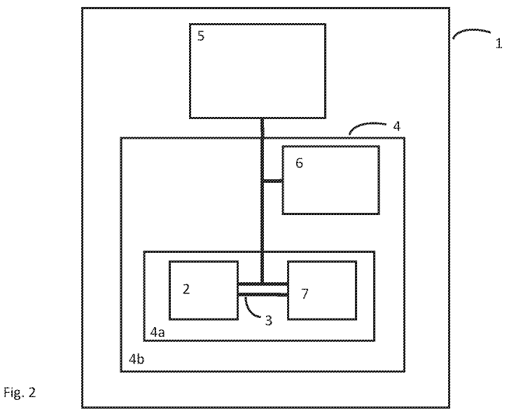

FIG. 2 shows the test environment 1 for the case of virtual validation, in which control unit 2 is implemented in the form of software, for example as a “virtual control unit.” In this case, processing unit 4 is, for example, provided only by a PC 4b that has stored thereon a simulator 4a in the form of a simulation software (such as, for example, the VEOS simulation platform from dSPACE GmbH). Simulator 4a simulates the virtual control unit as well as communication system 3 and environment 7; i.e., inter alia, the messages expected by the control unit 2 to be tested or also the vehicle for which control unit 2 is being developed. Simulator 4a coordinates the execution of the corresponding programs that were used to model the individual components. Here, too, PC 4b has stored thereon a viewer 6 that allows the user to display messages exchanged during the simulation on display device 5.

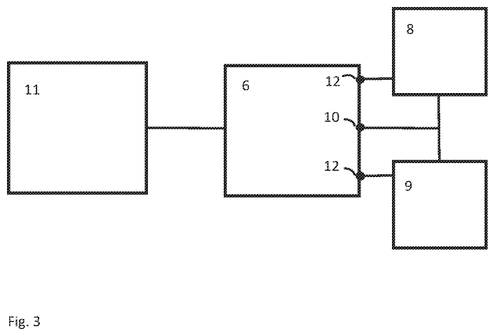

FIG. 3 schematically shows input device 11, which is in communication with viewer 6 for command input. Here, the user inputs commands into a graphical user interface (GUI) of viewer 6, e.g., using mouse and keyboard, the input commands relating to first display element 8 and/or second display element 9. The first and second display elements 8 and 9 can be considered as being part of the GUI of viewer 6. The commands concern, for example, the selection of elements/messages to be displayed, the configuration of the display element or the display mode.

In accordance with the present invention, an interface 10 is provided via which selected commands concerning first display element 8 and second display element 9 are equally and synchronously forwarded to both display elements. Thus, the corresponding commands are equally and substantially synchronously executed in both display elements. In accordance with the present invention, such a common interface 10 is set up with the instantiation of second display element 9, the instantiation of second display element 9 being performed automatically based on a positive filter result.

FIG. 3 shows additional interfaces 12 which are separate interfaces respectively of the first display element 8 and the second display element 9 with the viewer 6. These are intended for commands that are to act only one display element, such as, for example, the configuration of the view; i.e. the display form. Commands that are to act only on one of the two display elements are preferably input directly on the respective display element, e.g., by selection from selection list entries through mouse input and/or keyboard input.

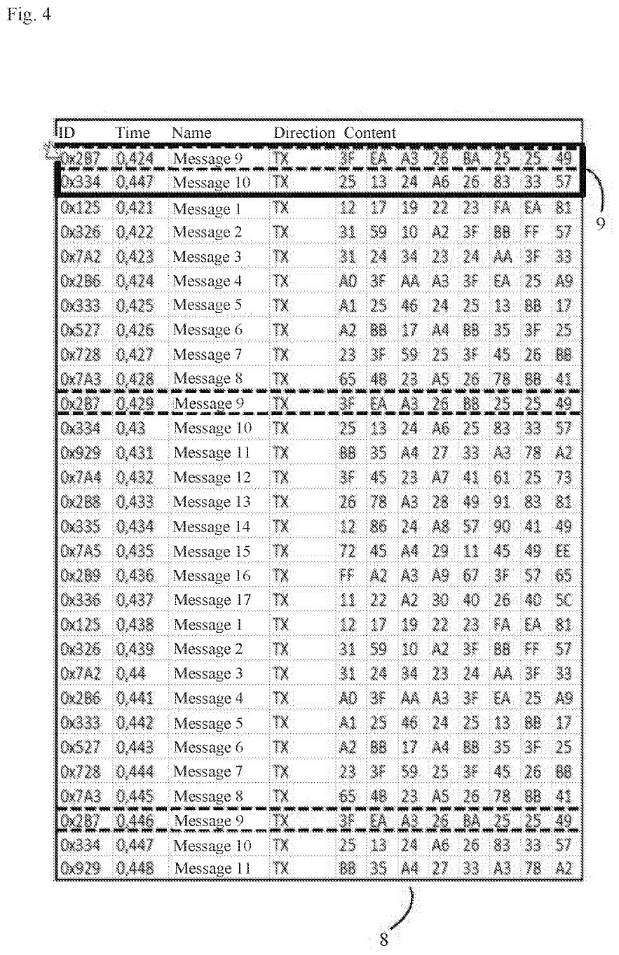

FIG. 4 shows an embodiment of the present invention, where second display element 9 is designed as a separate subregion of first display element 8.

First display element 8 is provided in the form of a display window. Here, information related to messages is displayed line by line, arranged in columns. In this exemplary embodiment, the columns show the ID, time stamp (time), name, transmission direction (direction) and content of each message. Further columns indicating, for example, the sender address and/or the receiver address may also be included. This information is listed at the top in the window header bar. Since in FIG. 4, the columns for the first display element coincide with the columns for the second display element, the information about the contents of the columns is specified only once for both display elements for the sake of clarity. In another embodiment with a different arrangement of columns, this information would additionally be specified separately in the second display element, or the second display element would be embodied as a separate display window.

In the first display element 8 of FIG. 4, the recorded messages are listed in a continuous chronological display mode, whereas in second display element 9, a static view has been selected, which lists only one instance with the current information of the filtered ID “0x287.” The message named “Message 10” is displayed here because a conditional filter was set which is activated upon receipt of a message with the ID “0x287” in order to also display the following message in second display element 9. (Thus, a new display element is not instantiated here for each positive filter result.) Moreover, in FIG. 4, a command to highlight a marked message is issued using the mouse. In accordance with the present invention, this command acts equally on both display elements. Therefore, all messages with the ID “0x287” are highlighted both in display element 9 and in display element 8.

An additional toolbar may be provided in at least one of the two display elements to select the display mode and to make other settings.

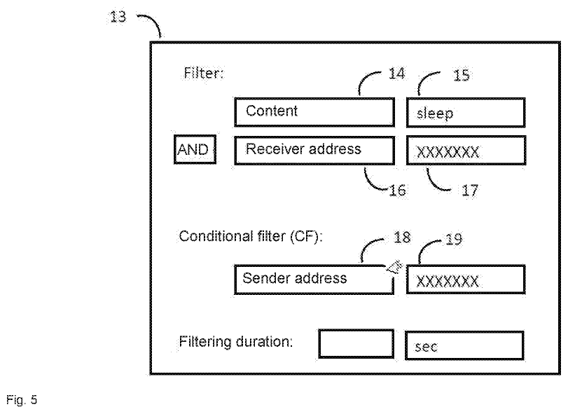

FIG. 5 schematically shows a GUI for setting a filter 13. The filter is configured by the user selecting filter criteria or filter instructions in boxes 14, 15, 16, 17, 18, 19 with the aid of pick lists or by making entries using the keyboard. For example, in FIG. 5, a selection has been made in box 14 according to which filtering for a message content is to be performed. The message content to be filtered for is specified in box 15 as “sleep.” Furthermore, this filter instruction is ANDed with a specific receiver address specified as “XXXXXXX.” Accordingly, all messages sent to the address “XXXXXXX” and containing a “sleep” command are filtered and displayed in a second display element in accordance with the present invention. In the case that this filter hits, a further (and thus conditional) filter instruction (conditional filter (CF)) is provided via boxes 18 and 19, namely that all messages having the sender address “XXXXXXX” are to be displayed also in second display element 9 in this case. The implementation of the filter instructions is effected via viewer 6. The identification of specific messages or events is thus made easier or possible for the user who must monitor a large number of quickly changing messages using the monitoring program.

By making a selection regarding the filtering duration, the user can set how long he or she wants the selected filter to act and the corresponding filter result to be displayed. It is also possible to configure a corresponding setting only for the conditional filter.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for displaying messages of a communication system, comprising:
exchanging, via the communication system, messages between a control unit to be tested and a test environment;
creating, receiving and processing, by at least one processing unit of the test environment, messages for the message exchange with the control unit to be tested as well as for command processing by a viewer of the at least one processing unit;
displaying, by a display device of the test environment, all received messages in a first display element in a first view;
checking, by the viewer, each received message in accordance with a filter instruction; and
in response to the check being positive for a respective message, additionally displaying, in a second display element in a second view, the respective message;
wherein the first display element and the second display element are interconnected by a common interface;
wherein an input command that acts on the first display element will also act equally on the second display element and/or an input command that acts on the second display element will also act equally on the first display element.

2. The method according to claim 1, wherein the first display element is provided by a first display window, and the second display element is provided by a second display window or a separate display region in the first display element.

3. The method according to claim 1, wherein the communication system is provided by a bus system or by a communication network.

4. The method according to claim 1, wherein the first view corresponds to a continuous display mode, a static display mode or a hierarchical display mode; and
wherein the second view corresponds to a continuous display mode, a static display mode or a hierarchical display mode.

5. The method according to claim 1, wherein one or more messages are displayed in different display modes in the first view and in the second view.

6. The method according to claim 1, wherein an input command corresponding to a search command, a freeze command or a selection command is provided.

7. The method according to claim 1, further comprising:
receiving, for a command to be applied to the first display element, a user selection of whether the command will also be applied to the second display element; and/or
receiving, for a command to be applied to the second display element, a user selection of whether the command will also be applied to the first display element.

8. The method according to claim 1, further comprising:
receiving, via the test environment, a user selection of a second, conditional filter instruction to be activated in response to a first filter instruction being positively checked.

9. The method according to claim 1, further comprising:
setting, via the viewer, the filter instruction to be active for a limited period of time.

10. The method according to claim 1, wherein the communication system comprises a plurality of different communication systems, and messages from the different communication systems are jointly displayed in the first and/or second display element(s).

11. The method according to claim 1, wherein the control unit to be tested is connected to a real-time computer of a hardware-in-the-loop (HIL) system and tested as a real control unit; or
wherein the control unit to be tested is simulated and tested as a virtual control unit on a personal computer (PC).

12. A test environment for testing a control unit connected via a communication system to the test environment, the test environment comprising:
at least one processing unit configured for creating, receiving and processing messages and for command processing by a viewer of the at least one processing unit;
an input device for user command input; and
a display device configured to display all received messages in a first display element in a first view;
wherein the at least one processing unit is configured to check, via the viewer, each received message in accordance with a filter instruction and, in response to the check being positive for a respective message, to additionally display the respective message in a second display element in a second view;
wherein the at least one processing unit is configured such that, via a common interface of the viewer, an input command that acts on the first display element will also act equally on the second display element and/or an input command that acts on the second display element will also act equally on the first display element.

13. The test environment according to claim 12, wherein the first display element is provided by a first display window, and the second display element is provided by a second display window or a separate display region in the first display element.

14. The test environment according to claim 12, wherein the communication system is provided by a bus system or by a communication network.

15. The test environment according to claim 12, wherein the first view corresponds to a continuous display mode, a static display mode or a hierarchical display mode; and
wherein the second view corresponds to a continuous display mode, a static display mode or a hierarchical display mode.

16. A non-transitory computer-readable medium having processor-executable instructions stored thereon for displaying messages of a communication system, wherein the processor-executable instructions, when executed, facilitate:
exchanging, via a communication system, messages between a control unit to be tested and a test environment;
creating, receiving and processing, by at least one processing unit of the test environment, messages for the message exchange with the control unit to be tested as well as for command processing by a viewer of the at least one processing unit;
displaying, by a display device of the test environment, all received messages in a first display element in a first view;
checking, by the viewer, each received message in accordance with a filter instruction; and
in response to the check being positive for a respective message, additionally displaying, in a second display element in a second view, the respective message;
wherein the first display element and the second display element are interconnected by a common interface;
wherein an input command that acts on the first display element will also act equally on the second display element and/or an input command that acts on the second display element will also act equally on the first display element.

17. The non-transitory computer-readable medium according to claim 16, wherein the first display element is provided by a first display window, and the second display element is provided by a second display window or a separate display region in the first display element.

18. The non-transitory computer-readable medium according to claim 16, wherein the communication system is provided by a bus system or by a communication network.

19. The non-transitory computer-readable medium according to claim 16, wherein the first view corresponds to a continuous display mode, a static display mode or a hierarchical display mode; and
wherein the second view corresponds to a continuous display mode, a static display mode or a hierarchical display mode.
